(19) United States
(12) Patent Application Publication
(10) Pub. No.: US 2025/0265024 A1
(43) Pub. Date: Aug. 21, 2025

(54) STORAGE MEDIUM, CONTROL METHOD, AND PRINTING SYSTEM

(71) Applicant: CANON KABUSHIKI KAISHA, Tokyo (JP)

(72) Inventor: Hiroaki Morimoto, Kanagawa (JP)

(21) Appl. No.: 19/045,788

(22) Filed: Feb. 5, 2025

(30) Foreign Application Priority Data
Feb. 21, 2024 (JP) 2024-024828
Apr. 12, 2024 (JP) 2024-064797

(51) Int. Cl. G06F 3/12

(52) U.S. Cl. CPC G06F 3/1254; G06F 3/1204

(57) ABSTRACT

The present invention is directed to a non-transitory computer-readable storage medium storing a computer program that extends a function of a generative AI service, the computer program causing a computer of an information processing apparatus to: acquire, from a user terminal, a natural language input related to a print instruction from a user, the print instruction being accepted through the generative AI service; determine a print setting on the basis of the natural language input related to the print instruction; and return the determined print setting to the user terminal.

### BACKGROUND OF THE INVENTION

### Field of the Invention

The present invention relates to a storage medium, a control method, and a printing system.

### Description of the Related Art

Conversational AI, including chatbots and generative AI, has been developing rapidly in recent years. With this development, a variety of services using conversational AI are being provided. Japanese Patent Laid-Open No. 2019-207513 proposes a printing assistance system that makes print settings in print jobs through a chatbot.

However, this conventional technique has the following issue. This technique makes print settings by having the chatbot answer a series of questions, but when an instruction other than one for print settings, such as an instruction for the printer to print, is input, the print settings will not be made having accurately (appropriately) interpreted the input text. There is thus a problem in that it is difficult for a computer to automatically send a print job to the printer on the basis of instructions input for a printing instruction.

### SUMMARY OF THE INVENTION

The present invention enables the realization of a system for appropriately determining print settings on the basis of a printing instruction input as natural language.

One aspect of the present invention provides a non-transitory computer-readable storage medium storing a computer program that extends a function of a generative AI service, the computer program causing a computer of an information processing apparatus to: acquire, from a user terminal, a natural language input related to a print instruction from a user, the print instruction being accepted through the generative AI service; determine a print setting on the basis of the natural language input related to the print instruction; and return the determined print setting to the user terminal.

Another aspect of the present invention provides a non-transitory computer-readable storage medium storing a computer program that uses a generative AI service, the computer program causing a computer of a user terminal to: accept a natural language input related to a print instruction from a user, through a generative AI interaction region in a settings screen; generate instruction text to the generative AI service on the basis of the natural language input accepted; send the instruction text generated to the generative AI service, and acquire a print setting determined by a plugin that extends a function of the generative AI service; and cause the user to confirm, through the settings screen, the print setting acquired.

Still another aspect of the present invention provides a control method for an information processing apparatus that extends a function of a generative AI service, the control method comprising: acquiring, from a user terminal, a natural language input related to a print instruction from a user, the print instruction being accepted through the generative AI service; determining a print setting on the basis of the natural language input related to the print instruction; and returning the determined print setting to the user terminal.

Yet still another aspect of the present invention provides a control method for a user terminal that uses a generative AI service, the control method comprising: accepting a natural language input related to a print instruction from a user, through a generative AI interaction region in a settings screen; generating instruction text to the generative AI service on the basis of the natural language input accepted; sending the instruction text generated to the generative AI service, and acquiring a print setting determined by a plugin that extends a function of the generative AI service; and causing the user to confirm, through the settings screen, the print setting acquired.

Still yet another aspect of the present invention provides a printing system comprising a user terminal, a generative AI server that provides a generative AI service, an information processing apparatus that extends a function of the generative AI service, and a printing apparatus, wherein the user terminal includes: one or more first memory devices that store a set of instructions; and one or more first processors that execute the set of instructions to: accept a natural language input related to a print instruction from a user, through a generative AI interaction region in a settings screen; generate instruction text to the generative AI service on the basis of the natural language input accepted; send the instruction text generated to the generative AI service, and acquire a print setting determined by a plugin that extends a function of the generative AI service; and cause the user to confirm, through the settings screen, the print setting acquired, and the information processing apparatus includes: one or more second memory devices that store a set of instructions; and one or more second processors that execute the set of instructions to: acquire the instruction text from the user terminal; determine a print setting on the basis of the natural language input related to the print instruction; and return the determined print setting to the user terminal.

Further features of the present invention will be apparent from the following description of exemplary embodiments with reference to the attached drawings.

### BRIEF DESCRIPTION OF THE DRAWINGS

FIG. 1 is a block diagram illustrating an example of the network configuration of a printing system according to one embodiment.

FIG. 2A is a block diagram illustrating the hardware configuration of each of apparatuses in the printing system according to one embodiment.

FIG. 2B is a block diagram illustrating the hardware configuration of each of apparatuses in the printing system according to one embodiment.

FIG. 3 is a block diagram illustrating the hardware configuration of a printer according to one embodiment.

FIG. 4A is a block diagram illustrating a software configuration related to printing according to one embodiment.

FIG. 4B is a block diagram illustrating a software configuration related to printing according to one embodiment.

FIG. 5A is a diagram illustrating an example of a printing application according to one embodiment.

FIG. 5B is a diagram illustrating an example of a printing application according to one embodiment.

FIGS. 6A-6B are a diagram illustrating a printing sequence according to one embodiment.

FIG. 7 is a diagram illustrating an example of instruction text sent to a generative AI server according to one embodiment.

FIG. 8 is a diagram illustrating print settings saved in a print settings database according to one embodiment.

FIG. 9 is a flowchart illustrating a processing sequence performed by a generative AI plugin server according to an embodiment.

FIG. 10 is a flowchart illustrating a processing sequence performed by a computer according to one embodiment.

FIG. 11 is a flowchart illustrating a processing sequence performed by a computer according to one embodiment.

FIGS. 12A-1 and 12A-2 are a diagram illustrating a printing sequence according to one embodiment.

FIGS. 12B-1 and 12B-2 are a diagram illustrating a printing sequence according to one embodiment.

FIGS. 13A-13B are a diagram illustrating a printing sequence according to one embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### System Configuration

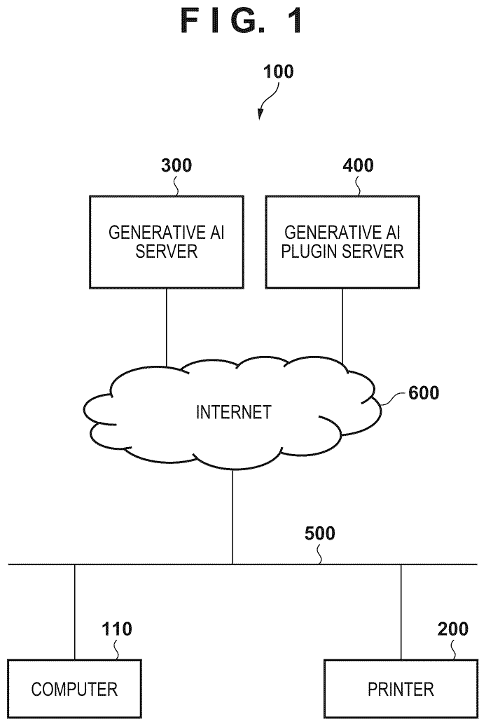

A first embodiment of the present invention will be described below. First, the network configuration of a printing system according to the present embodiment will be described with reference to FIG. 1.

As illustrated in FIG. 1, a printing system 100 is configured including a computer 110, which is a terminal apparatus, a printer (printing apparatus) 200 configured to be capable of printing, a generative AI server 300, and a generative AI plugin server 400. For example, the computer 110 and the printer 200 are installed in an office, and are communicatively connected to each other over an internal network 500. The internal network 500 is connected to the external Internet 6000 via a router (not shown). Here, the computer 110 is an example of a user terminal, and the generative AI plugin server 400 is an example of an information processing apparatus.

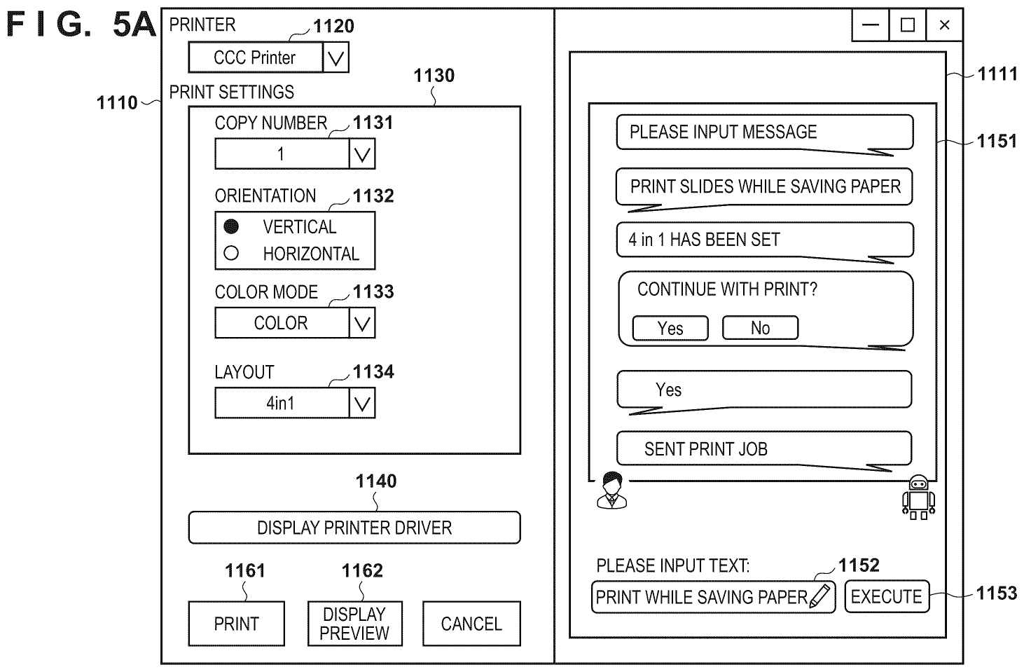

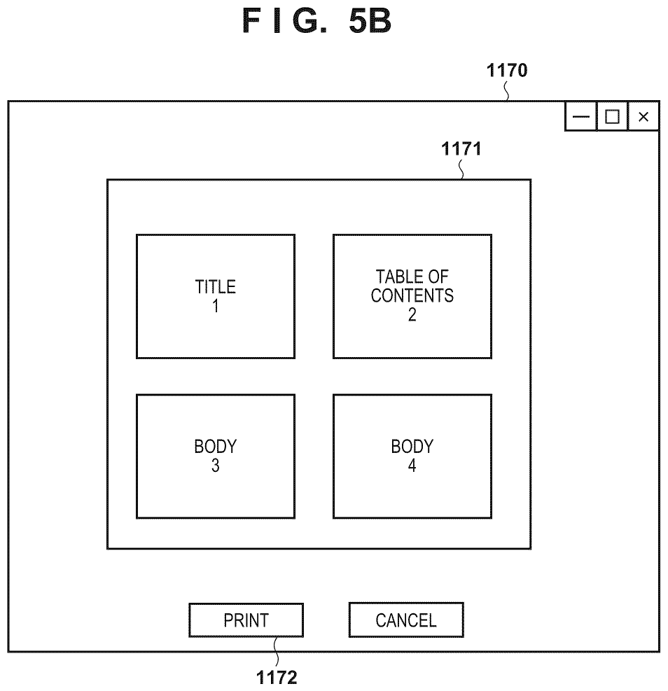

The generative AI server 300 is communicatively connected to the computer 110, the printer 200, and the generative AI plugin server 400 over the Internet 6000 and the internal network 500. The generative AI server 300 is a server managed by a business that provides a generative AI service. The generative AI plugin server 400 is communicatively connected to the computer 110, the printer 200, and the generative AI server 300 over the Internet 6000 and the internal network 500. The generative AI plugin server 400 is a server managed by a business that provides a printing service. In the present embodiment, the generative AI server 300, the generative AI plugin server 400, and generative AI control (a generative AI interaction region) 1150 on the computer 110 illustrated in FIG. 5 may be collectively referred to as a “generative AI system”. Note that the hardware in which the generative AI server 300, the generative AI plugin server 400, and the generative AI control 1150 are located may be separate, or these items may be located on the same hardware in an integrated manner. The internal network 500 may use a wired connection, or may use a wireless connection.

### Hardware Configuration

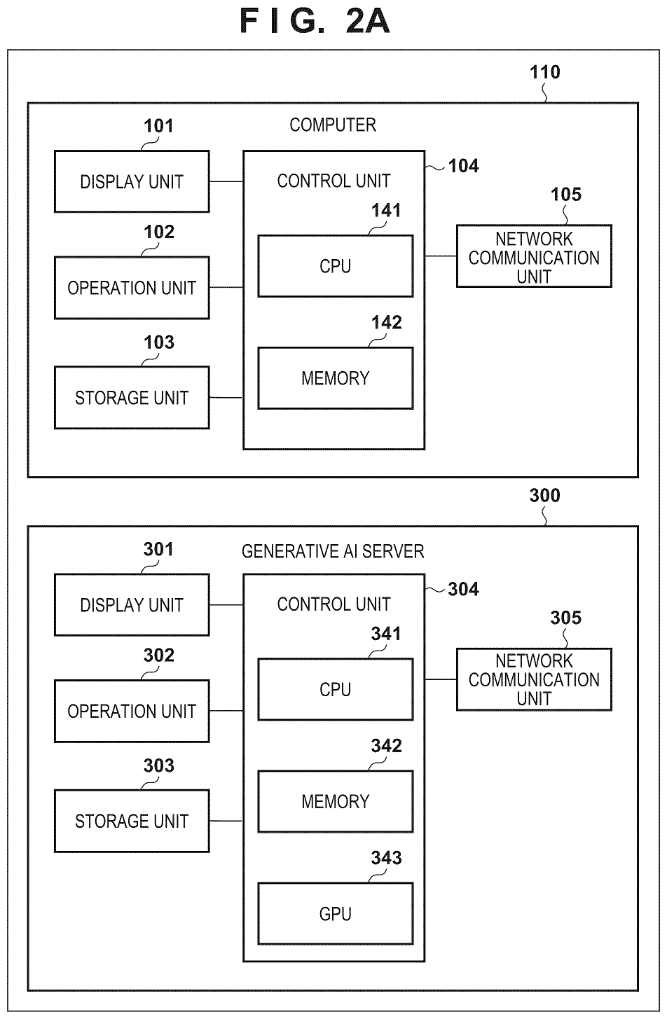

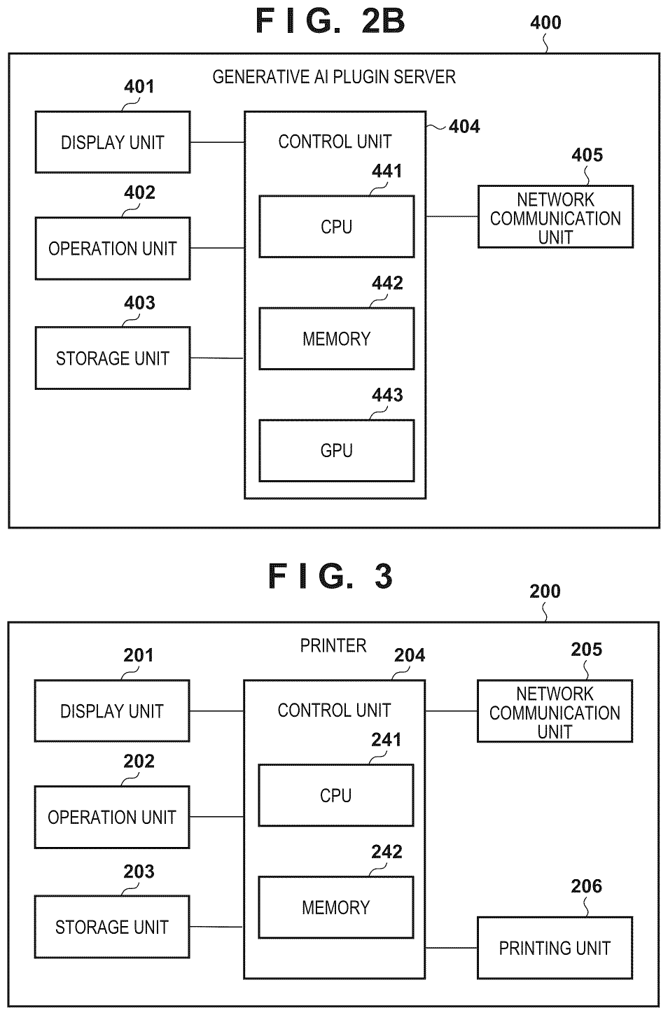

The hardware configuration of each apparatus of the printing system 100 according to the present embodiment will be described with reference to FIG. 2A to 3. FIG. 2A illustrates the hardware configuration of the computer 110 and the generative AI server 300. FIG. 2B illustrates the hardware configuration of the generative AI plugin server 400. FIG. 3 illustrates the hardware configuration of the printer 200.

As illustrated in FIG. 2A, the computer 110 includes a display unit 101, an operation unit 102, a storage unit 103, a control unit 104, and a network communication unit 105, which are communicatively connected to each other. The computer 110 is not particularly limited, and for example, a desktop or laptop personal computer, a tablet terminal, a smartphone, or the like can be used as the computer 110. The control unit 104 is configured including a Central Processing Unit (CPU) 141 and a memory 142, and controls the computer 110 as a whole.

The display unit 101 is constituted by a display such as a liquid crystal panel or the like, for example, and can display images and the like. The operation unit 102 is constituted by a mouse, a keyboard, and the like, for example, and can accept input operations made by a user. The storage unit 103 is constituted by, for example, a storage medium such as a hard disk, an SSD, or the like, and stores various types of programs (software) and the like necessary for the computer 110 to operate. The programs are loaded into the memory 142 and executed by the CPU 141 as necessary. The programs include programs for causing the CPU 141 to execute the parts and functions of the printing system 100. Note that these programs are not limited to programs stored in the computer 110. The programs may be stored in the printer 200, the generative AI server 300, or the generative AI plugin server 400, for example, or may be stored distributed among the computer 110, the printer 200, the generative AI server 300, and the generative AI plugin server 400. The network communication unit 105 inputs and outputs data with external apparatuses over an external network.

The generative AI server 300 includes a display unit 301, an operation unit 302, a storage unit 303, a control unit 304, and a network communication unit 305, which are communicatively connected to each other. The control unit 304 is configured including a CPU 341, a memory 342, and a Graphics Processing Unit (GPU) 343, and controls the generative AI server 300 as a whole. As described here, the hardware configuration of the generative AI server 300 is similar to the hardware configuration of the computer 110, and will therefore not be described in detail.

As illustrated in FIG. 2B, the hardware configuration of the generative AI plugin server 400 is substantially the same as the hardware configuration of the computer 110. Accordingly, in the present embodiment, the hardware configurations of the generative AI server 300 and the generative AI plugin server 400 will not be described. Note that it is preferable for the generative AI server 300 to have the GPU 343 and for the generative AI plugin server 400 to have a GPU 443.

As illustrated in FIG. 3, the printer 200 includes a display unit 201, an operation unit 202, a storage unit 203, a control unit 204, a network communication unit 205, and a printing unit 206, which are communicatively connected to each other. As long as a printing function is included, the printer 200 is not particularly limited, and for example, a Multi-Function Printer (MFP), a Single-Function Printer (SFP), or the like can be used. The control unit 204 is configured including a CPU 241 and a memory 242, and controls the printer 200 as a whole.

The display unit 201 is constituted by a display such as a liquid crystal panel or the like, for example, and can display images and the like. The operation unit 202 is constituted by a touch panel, various types of buttons, and the like, and can accept input operations made by a user. The storage unit 203 is constituted by, for example, a storage medium such as a hard disk, an SSD, or the like, and stores various types of programs (software) and the like necessary for the printer 200 to operate. The programs are loaded into the memory 242 and executed by the CPU 241 as necessary. The network communication unit 205 inputs and outputs data with external apparatuses over an external network. The printing unit 206 prints digital data stored in the storage unit 203, the memory 242, or the like as images on a printing sheet in accordance with instructions from the control unit 204. The printing method is not particularly limited, and for example, an ink-based method, a toner-based method, or the like can be used.

### Software Configuration

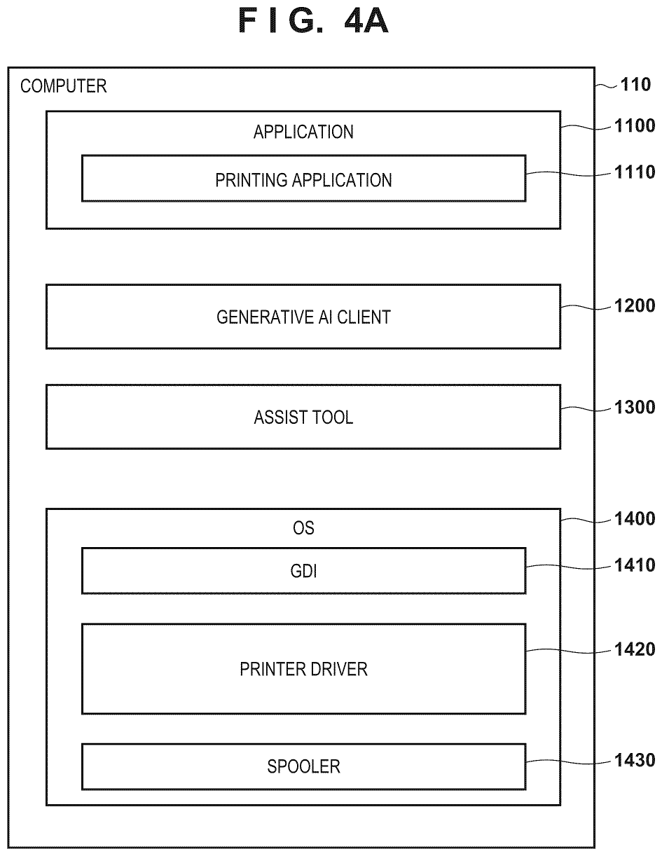

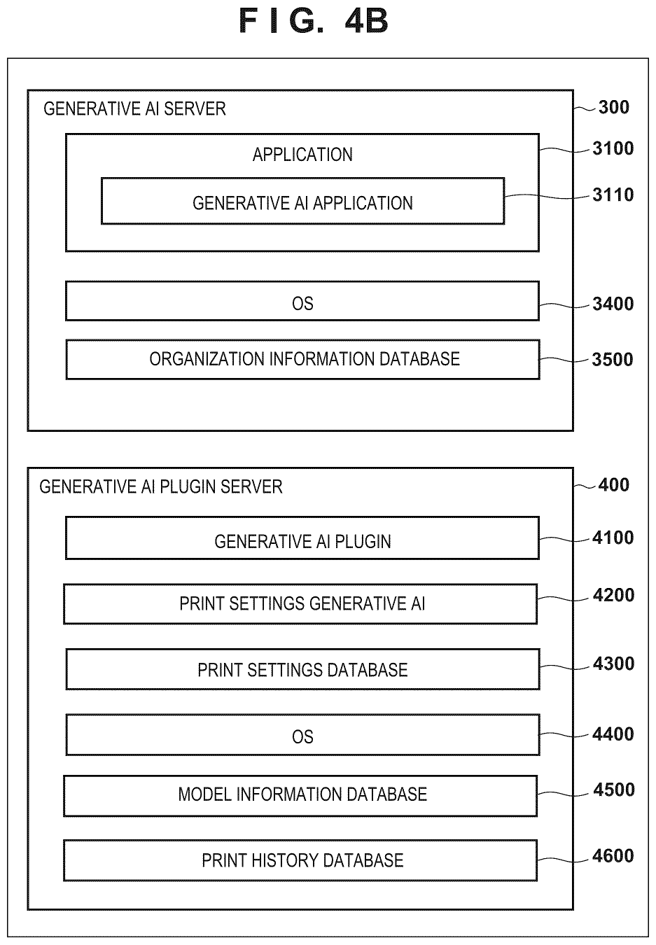

The software configuration of each apparatus of the printing system 100 according to the present embodiment will be described with reference to FIGS. 4A and 4B. FIG. 4A illustrates modules related to printing in the software configuration of the computer 110. FIG. 4B illustrates modules related to printing in the software configurations of the generative AI server 300 and the generative AI plugin server 400.

As illustrated in FIG. 4A, the computer 110 includes an application 1100, a generative AI client 1200, an assist tool 1300, and an Operating System (OS) 1400. The application 1100 includes any desired software, such as security software, spreadsheet software, browser software, and the like, and in the example illustrated in FIG. 4A, includes a printing application 1110. The printing application 1110 is an application having a printing function. The printing application 1110 is not particularly limited, and may include, for example, spreadsheet software, browser software, presentation software, or the like having a printing function.

When the printing function of the printing application 1110 is executed in response to a user operation, information or the like displayed in the display unit 101 of the computer 110 is sent to the printer 200, and printing is then performed. The printing function is realized by calling the interface of a Graphic Device Interface (GDI) 1410 (described later). The assist tool 1300 is software that generates a print preview image, operates a printer driver 1420, and the like using content created using the printing application 1110 and various print settings acquired from a print settings database 4300 (described later).

The generative AI client 1200 is client software executed by the computer 110. The generative AI client 1200 receives instruction text created by a user from the printing application 1110, generates instruction text to be sent to the generative AI server 300, and sends the instruction text to the generative AI server 300. Here, the instruction text to be sent is instruction text in which additional instructions have been added to the instruction text from the user.

The OS 1400 is software that controls the basic operations of the computer 110. The OS 1400 includes the GDI 1410, the printer driver 1420, and a spooler 1430. The printer driver 1420 is provided by the business that provides the printer 200. The application 1100, the printer driver 1420, and the like are all managed by the OS 1400, and can be used by being installed in the OS 1400. The printer driver 1420 is provided by the business that provides the OS 1400, and may be integrated into the OS 1400 in advance. The GDI 1410 is a component within the OS 1400 that provides an interface related to rendering, such as printing, to the exterior. The printer driver 1420 displays the print settings for printing by the printer 200 in a User Interface (UI). The printer driver 1420 also generates rendering data (Page Description Language (PDL)) that can be interpreted by the printer 200 when printing. The spooler 1430 performs processing for sending PDL generated by the printer driver 1420 to the printer 200. Although a configuration using Microsoft (registered trademark) Windows (registered trademark) as the OS is described here, a different OS may be used as the OS 1400. The print data received by the printer driver 1420 from the printing application 1110 may not only be data in GDI format, but also data in XML Paper Specification format (data in XPS format).

As illustrated in FIG. 4B, the generative AI server 300 includes an application 3100, an organization information database 3500, and an OS 3400. Note that the OS 3400 has substantially the same software configuration as the OS 1400, and thus the OS 3400 will not be described here. The application 3100 includes any desired software, and in the example illustrated in FIG. 4B, includes a generative AI application 3110. The generative AI application 3110 is an application having a generative AI interpretation processing function. The generative AI application 3110 interprets instruction text from a user sent from the generative AI client 1200, and determines a response to the instruction text. The generative AI application 3110 also determines, in accordance with the instruction text provided, whether a plugin needs to be called, as well as the plugin to be called to implement the instructed operation. The generative AI application 3110 further inputs information regarding the instruction text sent from the generative AI client 1200 to the called plugin. “Plugin” referred to here is a generative AI plugin 4100 (described later). The organization information database 3500 is a database referred to by the generative AI application 3110. Various types of content, such as spreadsheet files, presentation files, and the like, created within an organization that can use the generative AI application 3110 are stored in the organization information database 3500. The generative AI application 3110 can refer to the information of files saved in the organization information database 3500 in response to the instruction text from a user.

The generative AI plugin server 400 includes the generative AI plugin 4100, print settings generative AI 4200, the print settings database 4300, a model information database 4500, a print history database 4600, and an OS 4400. Note that the OS 4400 has substantially the same software configuration as the OS 1400, and thus the OS 4400 will not be described here. The generative AI plugin 4100 is any desired software associated with the generative AI application 3110, and is called from the generative AI application 3110. The generative AI plugin 4100 inputs the instruction text received from the generative AI application 3110 into the print settings generative AI 4200, and returns a result of that processing to the generative AI application 3110. One or more generative AI plugins 4100 are present in the generative AI plugin server 400. The model information database 4500 is a database referred to by the generative AI plugin 4100. Model-specific information, such as the paper size, paper type, and the like that can be used in each model of printer, device configuration information, or the like, is stored in the model information database 4500. By referring to the model information database 4500, the generative AI plugin 4100 can input information dependent on the model of the printer into the print settings generative AI 4200. The print history database 4600 is a database referred to by the generative AI plugin 4100. A combination of print settings used for printing up to that point is stored in the print history database 4600 on a user-by-user basis. By the generative AI plugin 4100 referring to the print history database 4600, the user can input the information of print settings used for printing up to that point into the print settings generative AI 4200.

The generative AI application 3110 determines the generative AI plugin 4100 to be called in accordance with a result of processing for interpreting natural language which is input. For example, the generative AI application 3110 determines that a generative AI plugin X is to be called when the result of the interpretation processing is determined to be content related to changing the print settings, that a generative AI plugin Y is to be called when the result is determined to be content related to executing the print settings, and the like. The print settings generative AI 4200 is a language model constructed using big data, including text data, and a deep learning technique. The print settings generative AI 4200 determines the optimal combination of print settings for achieving the printing desired by the user included in the instruction text that has been input.

The print settings database 4300 is a database that records information specifying the computer that sent instruction text in association with the combination of print settings determined by the print settings generative AI 4200.

### Example of Settings Screen

A screen 1111 displayed on the display unit 101 by the printing application 1110 according to the present embodiment will be described with reference to FIG. 5A. An output condition instruction including printing conditions and the like used when printing using the printer 200 can be input in the screen 1111 displayed on the display unit 101 by the printing application 1110. In this manner, in the present embodiment, the printing application 1110 also functions as input means for inputting an output condition.

The screen 1111 includes, as the printing conditions, a printer selection control 1120, a print settings control 1130, a printer driver control 1140, a generative AI control 1150, a print button 1161, and a preview display button 1162. Note that other output conditions for these printing conditions may be included in the screen 1111. For example, if the printer 200 is configured to be capable of stapling, stapling conditions for setting the position, number, and the like of the staples may be included. Additionally, if the printer 200 is configured to be capable of cutting processing, cutting conditions for setting the position of the cut and the like may be included. The print button 1161 and the preview display button 1162 are examples of operation objects, and are operated to perform printing and a preview display, respectively.

In the printer selection control 1120, a list of printers that can be used by the computer 110, i.e., that can receive print jobs from the computer 110, is displayed in a UI on the basis of the printer data stored in the storage unit 103 in advance. The user can select the printer 200 to which a print job is to be sent by operating the printer selection control 1120. In FIG. 5A, the name of the printer 200 is “CCC Printer”.

The print settings control 1130 is a setting region for making the print settings, and includes a copy number control 1131, an orientation control 1132, a color mode control 1133, and a layout control 1134. The copy number control 1131 is an item for setting the number of copies to be printed. In FIG. 5A, the copy number control 1131 is set to “1”. The orientation control 1132 is an item for selecting the orientation of the sheet for printing. In the present embodiment, “portrait”, in which the orientation for printing is set to the vertical direction, and “landscape”, in which the orientation for printing is set to the horizontal direction, can be selected. In FIG. 5A, the orientation control 1132 is set to “portrait”. The color mode control 1133 is an item for selecting “color”, for setting color printing, or “black and white”, for setting black and white printing. In FIG. 5A, the color mode control 1133 is set to “color”. Note that the print settings control 1130 is not limited to including the copy number control 1131 to the color mode control 1133, and it is sufficient for at least one of these items to be included. The print settings control 1130 may also include other setting items, such as an item for selecting the paper size, an item for selecting single-sided printing or double-sided printing, an item for selecting the number of pages per sheet, and the like. The layout control 1134 is an item for selecting the document pages to be printed on each sheet in layout printing. The layout control 1134 has setting values such as “1 in 1”, for laying out and printing one document page per sheet, “2 in 1”, for laying out and printing two document pages per sheet, and “4 in 1”, for laying out and printing four document pages per sheet. In FIG. 5A, the layout control 1134 is set to “4 in 1”. If the user intends to save paper when printing, setting the setting value of the layout control 1134 makes it possible to obtain a printed product according to those intentions.

When operated by the user, the printer driver control 1140 displays an advanced print settings screen provided by the printer driver corresponding to the “CCC Printer” displayed in the printer selection control 1120. Through this, the user can make detailed changes to the print setting values in the print settings screen of the printer driver. Then, when the print settings screen of the printer driver is closed, the content of the changes to the print setting values in the print settings screen are stored in the storage unit 103.

The generative AI control 1150 includes a chat display region 1151, an instruction input part 1152, and an execute button 1153. The printing application 1110 displays instruction text (natural language) input by the user, text corresponding to processing results received from the generative AI server 300, and the like in the chat display region 1151 in an interactive format. Through the instruction input part 1152, the printing application 1110 provides a function for inputting desired instructions representing processing details. The user can input the instructions through the operation unit 102, which is a keyboard and the like, for example. Alternatively, speech spoken by the user may be accepted as audio input through a microphone (not shown). In FIG. 5A, instruction text “print while saving paper” is input in the instruction input part 1152 in Japanese. Note that the text input into the instruction input part 1152 is not limited to text for changing the setting value for layout printing, and can be any desired text, such as, for example, changing the color mode, enlarging or reducing the printing range, or the like. The execute button 1153 is a button for sending an instruction including the instructions input to the instruction input part 1152 to the generative AI server 300. It is also desirable to reflect the determined print settings, e.g., “4 in 1”, in the layout control 1134, which is the corresponding control, in accordance with the instruction text input to the instruction input part 1152, as illustrated in FIG. 5A. In other words, although each control for the print settings can be set according to the user input, settings made in accordance with interactions with the generative AI control 1150 may be reflected as well.

### Preview Display

A preview display displayed on the display unit 101 by the assist tool 1300 according to the present embodiment will be described with reference to FIG. 5B. When the print button 1161 in the screen 1111 is operated, the printing application 1110 sends the print job to the printer 200 on the basis of the print settings specified in the print settings control 1130, without displaying a print preview image display UI 1170. However, when the preview display button 1162 in the screen 1111 is operated, the printing application 1110 displays the print preview image display UI 1170 provided by the assist tool 1300.

The print preview image display UI 1170 includes a print preview display region 1171 and a print button 1172. The assist tool 1300 displays a printing result preview image in the print preview display region 1171 on the basis of the print settings determined by the print settings generative AI 4200 and the content created by the printing application 1110. This enables the user to confirm the printed product to be printed by the printer 200 before the printed product is actually output. When the print button 1172 is operated, the printing application 1110 starts print job sending processing for the content displayed in the print preview image display UI 1170. As such, the print button 1172 is an example of an operation object.

### Sequence

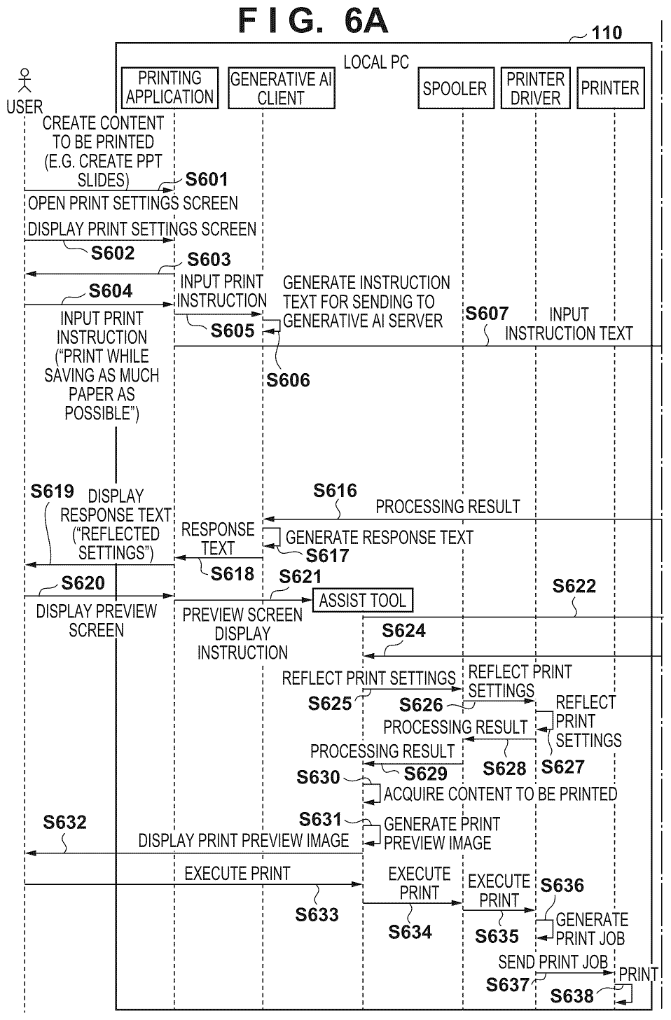

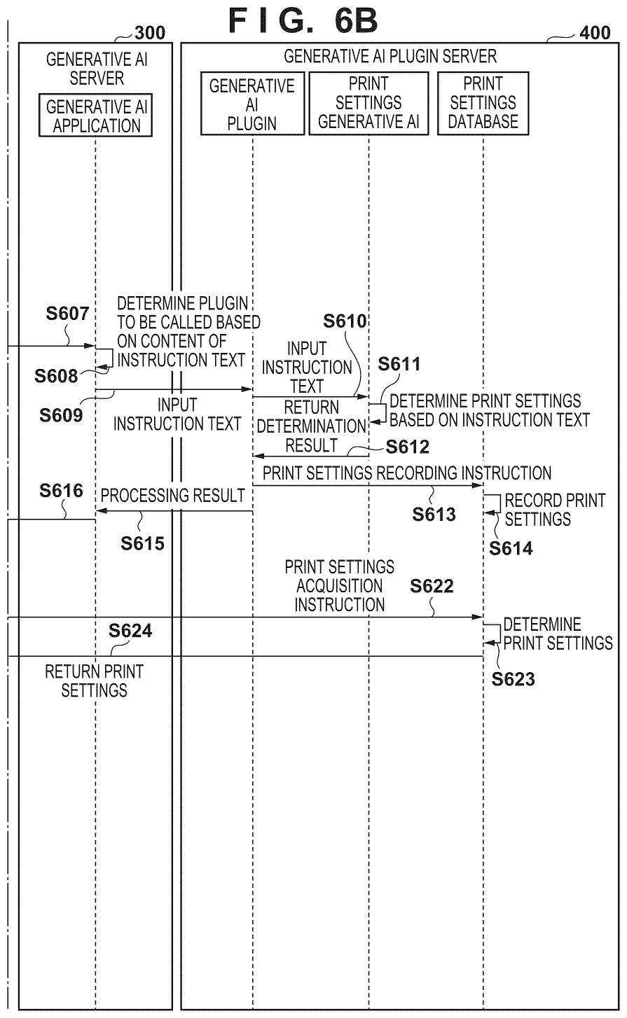

A sequence of processing performed among the elements constituting the computer 110, the generative AI server 300, and the generative AI plugin server 400 according to the present embodiment will be described next with reference to FIGS. 6A-6B. The numbers following “S” hereinafter indicate step numbers in the sequence.

In step S601, the printing application 1110 creates content to be printed in accordance with operation instructions made by the user. Presentation slides, documents, charts, graphs, and the like can be given as examples of the content. After the content has been created, in step S602, the printing application 1110 accepts an instruction from the user, and in step S603, displays the print settings screen 1111 on the display unit 101. Next, in step S604, the printing application 1110 accepts a print instruction for performing desired printing using natural language through the instruction input part 1152 in the print settings screen 1111. An example of the printing instruction is an instruction that includes conditions for printing, such as “print while saving as much paper as possible”. In step S605, the printing application 1110 inputs the print instruction input by the user, the IP address of the computer 110, the printer name (print queue name) selected as the destination for sending the print job, and the like to the generative AI client 1200. In this manner, the printing application 1110 inputs the IP address, which is identification information of the apparatus (the user terminal) that requested the print instruction through the print settings screen 1111, and the name (the printer name), which is identification information of the selected printing apparatus, along with the natural language input.

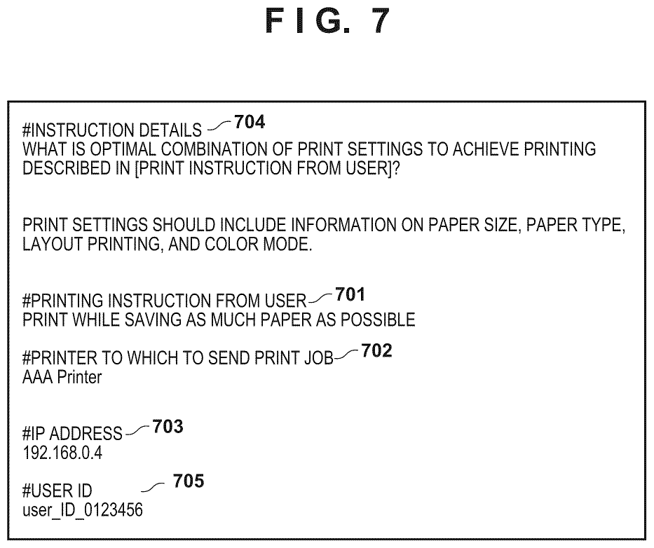

Upon receiving the print instruction, in step S606, the generative AI client 1200 generates instruction text to be sent to the generative AI server 300 using the received information. The IP address of the computer 110 for specifying the source of the instruction text, the printer name selected in the print settings screen 1111 as the destination for sending the print job, and the like are added to the instruction text as additional information, in addition to the print instruction input by the user. The instruction text to be sent to the generative AI server 300 will be described later with reference to the specific example illustrated in FIG. 7. Next, in step S607, the generative AI client 1200 sends the generated instruction text to the generative AI application 3110 of the generative AI server 300.

Upon receiving the instruction text, in step S608, the generative AI application 3110 interprets the content of the instruction text and determines the generative AI plugin 4100 to be called. Then, in step S609, the generative AI application 3110 inputs the instruction text received from the generative AI client 1200 to the generative AI plugin determined.

Upon receiving the instruction text, in step S610, the generative AI plugin 4100 inputs the received instruction text to the print settings generative AI 4200. In step S611, the print settings generative AI 4200 determines an optimal combination of print settings for obtaining the output result desired by the user by interpreting the print instruction from the user included in the instruction text. Note that the print settings that can be set differ depending on the type of the printer 200. The print settings generative AI 4200 may be configured to determine the print settings that can be set by the printer 200 specified by the printer name to which the print job is sent, included in the instruction text received in step S609, by referring to a print settings function database (not shown). Furthermore, in step S611, the print settings generative AI 4200 may determine the combination of the print settings on the basis of the determined print settings that can be set and the instruction text. Such a configuration makes it possible for the print settings generative AI 4200 to determine print settings that can be designated by the printer 200. Next, in step S612, the print settings generative AI 4200 returns the determined combination of print settings to the generative AI plugin as a determination result.

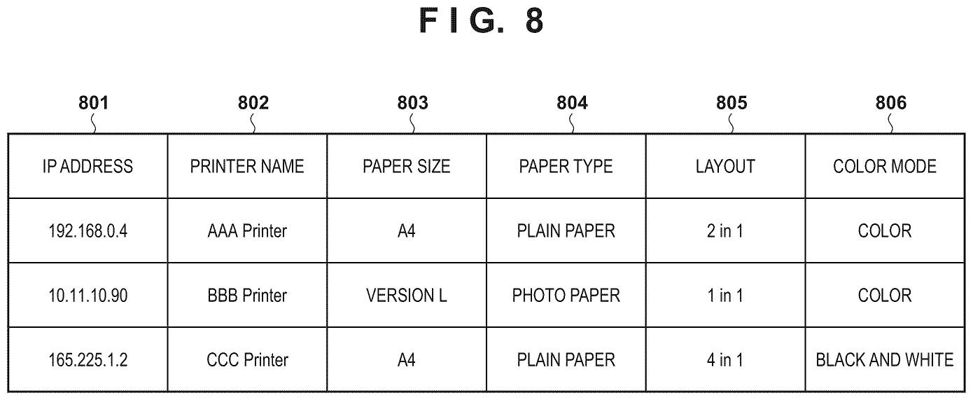

Upon receiving this response, in step S613, the generative AI plugin 4100 records the combination of the print settings included in the response, the IP address of the computer 110 included in the instruction text received in step S609, and the printer name in association with each other in the print settings database 4300. A specific example of the information recorded in the print settings database will be described later with reference to FIG. 8. Next, in step S615, the generative AI plugin 4100 returns the response received in step S612 to the generative AI application 3110 as a result of the processing performed in step S609.

Then, in step S616, the generative AI application 3110 returns the processing result received in step S615 to the generative AI client 1200 as a result of the processing performed in step S607. Next, in step S617, the generative AI client 1200 generates response text for the printing application 1110 from the received processing result. The response text is text explaining the combination of print settings determined by the print settings generative AI 4200 in step S611 to the user using natural language, and is displayed in the generative AI control 1150. In step S618, the generative AI client 1200 responds to the printing application 1110 using the response text generated as a result of the processing performed in step S605.

In step S619, the printing application 1110 displays the received response text to the user. The details of the applied print settings (“4 in 1 has been set”), a message confirming whether to execute the print, a button enabling the user to specify whether to execute the print thereafter, and the like, as illustrated in the chat display region 1151, can be given as an example of the display of the response text. Additionally, in step S612, the print settings generative AI 4200 may return information that displays a button enabling one or more print settings to be specified, such that the user can additionally specify desired print settings.

In step S620, the printing application 1110 accepts a user operation of the preview display button provided in the print settings screen 1111. When the preview display button is operated, in step S621, the printing application 1110 launches the assist tool 1300 and issues a preview image display instruction. Here, the instruction in step S621 includes information for specifying print settings to be acquired from the print settings database 4300. This information includes the IP address of the computer 110, the printer name designated as the destination to which the print job is to be sent, and information on the location (a file path name) where the content to be printed, which is used for generating the print preview image, is stored.

Upon receiving the stated instruction, in step S622, the assist tool 1300 accesses the print settings database 4300 and instructs the combination of print settings to be used for the preview display to be acquired. Here, the instruction in step S622 includes the IP address of the computer 110 and the printer name designated as the destination to which the print job is to be sent as information for specifying the print settings to be acquired. Having received the instruction, the print settings database 4300 acquires the combination of print settings recorded in association with the IP address and the printer name included in the instruction in step S623. Then, in step S624, the print settings database 4300 returns the acquired combination of print settings to the assist tool 1300.

In step S625, the assist tool 1300 instructs the spooler 1430 to apply the acquired combination of print settings in the printer driver 1420. Having received the instruction, in step S626, the spooler 1430 instructs the printer driver 1420 associated with the printer set as the destination for sending the print job to apply the various print settings. Having received the instruction, in step S627, the printer driver 1420 applies the various print settings that have been designated, and in S628, returns the result of that processing to the spooler 1430. Having received the processing result from the printer driver 1420, in step S629, the spooler 1430 returns that processing result to the assist tool 1300.

Next, in step S630, the assist tool 1300 acquires the content to be printed on the basis of the information on the location where the content to be printed is stored, received in step S621. Note that the assist tool 1300 may acquire the information on the location where the content to be printed is stored from the print settings database 4300 rather than from the printing application 1110. Alternatively, the assist tool 1300 may acquire the content to be printed itself from the print settings database 4300. In these cases, the information on the location where the content to be printed is stored, or the content to be printed itself, is specified by the printing application 1110 or the generative AI client 1200, and as a result, the information is included in the instruction text in step S607.

Next, in step S631, the assist tool 1300 generates a print preview image on the basis of the content to be printed, acquired in step S630, and the combination of the print settings, acquired in step S624. Then, in step S632, the assist tool 1300 displays the generated print preview image to the user. The print preview image is displayed in the print preview display screen displayed by the assist tool 1300. Then, in step S633, the assist tool 1300 accepts an instruction to execute the print job, made by the user who has confirmed the print preview image operating the print button on the print preview display screen. Having received the instruction to execute the print job, the assist tool 1300 instructs the spooler 1430 to execute the print job in step S634. Then, in step S635, the spooler 1430 instructs the printer driver 1420 to execute the printing processing. Having received the instruction to execute the printing processing, the printer driver 1420 generates the print job on the basis of the instruction in step S636, and sends the generated print job to the printer in step S637. Having received the print job, the printer executes the printing processing in accordance with the details of the print job in step S638, after which the sequence ends.

### Example of Instruction Text

An example of the instruction text sent to the generative AI server 300 in step S606 will be described next with reference to FIG. 7. The instruction text includes the information indicated by 701 to 705. 701 indicates the print instruction input by the user to the instruction input part 1152 in step S604. 702 indicates the printer name set as the printer to which the print job is to be sent in the printer selection control 1120. 703 indicates the IP address of the computer 110. 704 indicates the details of the instructions to the generative AI application 3110. Specifically, the details of the instructions inquire about the combination of print settings in accordance with the instruction text from the user. 705 indicates user identification information for identifying the user who input the instruction text. Note that 702, 703, 704, and 705 are not details explicitly input to the instruction input part 1152, but are rather sentences automatically added by the generative AI client 1200. The generative AI application 3110 determines the plugin to be called by interpreting the content of this instruction text.

### Print Settings

The print settings stored in the print settings database 4300 according to the present embodiment will be described with reference to FIG. 8. A combination of print settings pertaining to paper size 803, paper type 804, layout 805, and color mode 806 is stored in the database using an IP address 801 and a printer name 802 as keys. The assist tool 1300 can specify a combination of print settings to be acquired, which are stored in the database, using the IP address of the computer 110 and the printer name set as the destination for sending the print job as keys. Note that the print settings illustrated in FIG. 8 are merely examples, and are not intended to limit the present invention. Other desired print settings can be combined instead of or in addition to these print settings.

### Processing Sequence by Print Setting Generative AI

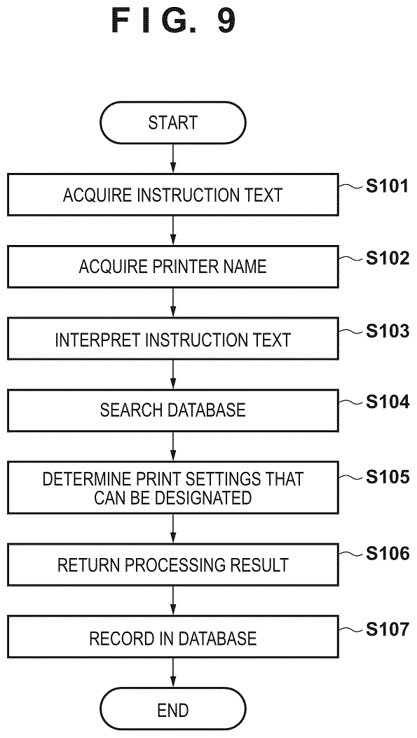

A processing sequence by the print settings generative AI 4200, executed by the generative AI plugin server 400 according to the present embodiment, will be described next with reference to FIG. 9. The processing described hereinafter is realized, for example, by a CPU 441 of the generative AI plugin server 400 reading out a program stored in a storage unit 403 into a memory 442 and executing the program.

In step S101, the CPU 441 acquires the instruction text generated from the user instructions input in the computer 110 via the generative AI server 300. The instruction text includes a print instruction from the user, the IP address of the computer 110 specifying the source of the instruction text, and the printer name of the printer to which the instruction text is to be sent, as illustrated in FIG. 7. In step S102, the CPU 441 acquires the printer name from the received instruction text.

In step S103, the CPU 441 interprets the instruction text. Specifically, the CPU 441 interprets the instruction details 704 and the print instruction 701 from the user, illustrated in FIG. 7. For example, here, keywords related to the print settings are extracted from the instruction details, and the keywords are used as search keys when acquiring the combination of the print settings. Next, in step S104, the CPU 441 searches for print settings that can be designated from the print settings database 4300 using the printer name acquired in step S102 and the search keywords extracted in step S103, and in step S105, determines the combination of the print settings found in the search.

In step S106, the CPU 441 returns the result of the processing to the generative AI server 300. Furthermore, in step S107, the CPU 441 records the determined combination of print settings in the print settings database 4300 in association with the IP address of the computer 110 and the printer name, after which the processing of this flowchart ends.

### Processing Sequence by User Terminal

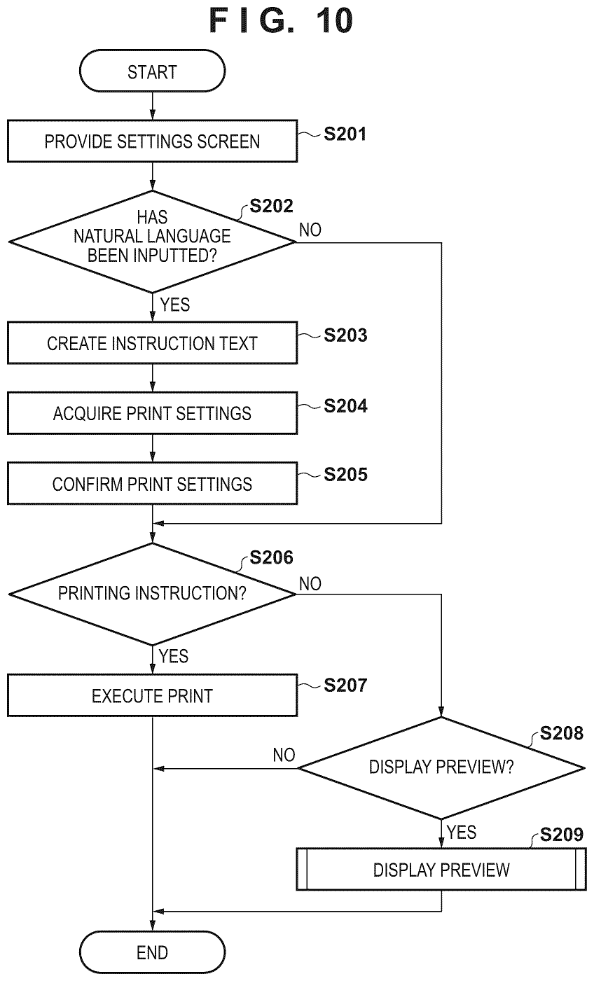

A processing sequence by the computer (user terminal) 110 according to the present embodiment will be described next with reference to FIG. 10. The processing described hereinafter is realized, for example, by the CPU 141 of the computer 110 reading out a program stored in the storage unit 103 into the memory 142 and executing that program.

First, in step S201, the CPU 141 displays the print settings screen 1111 on the display unit 101 in response to an instruction from the printing application 1110. In step S202, the CPU 141 determines whether natural language input has been received from the user through the generative AI control (generative AI interaction region) 1150 of the print settings screen 1111. The sequence moves to step S203 if natural language input has been received, and to step S206 if not.

In step S203, the CPU 141 generates instruction text, such as that illustrated in FIG. 7, on the basis of the natural language input received and printing apparatus selection information and the like. Next, in step S204, the CPU 141 acquires the print settings determined by the generative AI plugin server 400 by inputting the generated instruction text into the generative AI server 300. Then, in step S205, the CPU 141 confirms the acquired print settings with the user through the print settings screen 1111. Here, as illustrated in FIG. 5A, an inquiry as to whether to execute the print may be made along with the confirmation that the print settings determined in the generative AI control 1150 of the print settings screen 1111 (e.g., 4 in 1) have been set. Additionally, in the print settings screen 1111, the CPU 141 updates the details of the print settings control 1130 in accordance with the acquired print settings.

Then, in step S206, the CPU 141 determines whether a print instruction has been received. Here, the print instruction corresponds to the print button 1161 being operated, or a print instruction received through the generative AI control 1150. If a print instruction has been received, the sequence moves to step S207, and if not, the sequence moves to step S208. In step S207, the CPU 141 causes the selected printing apparatus to execute the print through the printer driver 1420, after which the processing of the flowchart ends.

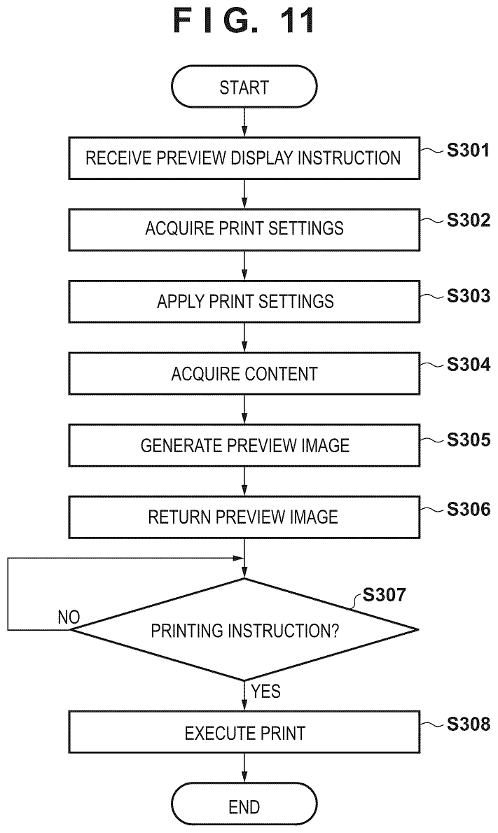

On the other hand, in step S208, the CPU 141 determines whether a preview display has been received as a result of the preview display button 1162 being operated. If the preview display has been received, the sequence moves to step S209, and if not, the processing of the flowchart ends. In step S209, the CPU 141 performs the preview display, after which the processing of the flowchart ends. The preview display will be described in detail with reference to FIG. 11.

### Preview Display

A processing sequence for the preview display, performed in step S209, will be described in detail with reference to FIG. 11. A preview display function of the assist tool 1300 will be described here. The assist tool 1300 is an example of display control means. The processing described hereinafter is realized, for example, by the CPU 141 of the computer 110 reading out a program stored in the storage unit 103 into the memory 142 and executing that program.

In step S301, the CPU 141 receives an instruction to display the preview image through the printing application 1110, and the assist tool 1300 is launched. Specifically, when the preview display button 1162 in the screen 1111 is operated, the CPU 141 determines that an instruction to display the preview image has been received, and launches the assist tool 1300. The processing thereafter is performed by the assist tool 1300. Next, in step S302, the CPU 141 accesses the print settings database 4300 and acquires the print settings of the print job. The print settings acquired here correspond to the print settings recorded in the aforementioned step S107. In step S303, the CPU 141 instructs the acquired combination of print settings to be applied in the printer driver 1420.

In step S304, the CPU 141 acquires the content included in the preview display instruction. For example, the preview display instruction need not include the content data itself, and in this case, information on the location where the content data is stored is included instead. The location where the content data is stored may be the computer 110, or the print settings database 4300 of the generative AI plugin server 400. Note that when data stored in the database is used as the content data, the information regarding the storage location is included in the instruction text.

In step S305, the CPU 141 generates a print preview image from the content data on the basis of the print settings, and displays the generated print preview image to the user through the printing application or the like. In step S307, the CPU 141 determines whether a print instruction has been received through the preview image display screen, and if a print instruction has been received, the sequence moves to step S308. In step S308, the CPU 141 instructs the printer driver 1420 to execute the print, after which the processing of the flowchart ends.

As described above, a printing system according to the present embodiment is configured including a user terminal, a generative AI server that provides a generative AI service, an information processing apparatus that extends a function of the generative AI service, and a printing apparatus. In particular, the user terminal accepts a natural language input related to a print instruction from a user through a generative AI interaction region of a settings screen, and generates instruction text to the generative AI service on the basis of the natural language input accepted. Additionally, the user terminal sends the generated instruction text to the generative AI service, acquires a print settings determined by a plugin that extends a function of the generative AI service, and causes the user to confirm the acquired print setting through the settings screen. In addition, the information processing apparatus acquires the instruction text from the user terminal, determines the print setting on the basis of the natural language input related to the print instruction, and returns the determined print setting to the user terminal. In this manner, according to the present embodiment, optimal print settings can be automatically determined by a print setting generative AI interpreting a print instruction made by a user using natural language. In addition, the generative AI plugin server 400 provided by the business that provides the printer 200 determines the print settings, and thus print settings can be determined which fully utilize the printing capabilities that can be specified in the printer 200. Furthermore, in the present embodiment, acquiring the print settings determined by the assist tool and the content to be printed makes it possible to print using the print settings determined automatically.

The present invention is not intended to be limited to the foregoing embodiment, and many variations and changes can be made within the scope thereof. The present invention can also be realized as a process executed by supplying a program implementing one or more functions of the foregoing embodiment to a system or apparatus over a network or by a storage medium and then causing one or more processors of a computer of the system or apparatus to read out and execute the program. The present invention can also be implemented by a circuit (for example, an ASIC) for implementing one or more functions.

Additionally, in the foregoing embodiment, the computer 110 includes an operation unit for inputting the output conditions of the printer 200. However, the present invention is not limited thereto, and it is sufficient for at least one apparatus among the computer 110, the generative AI server 300, the generative AI plugin server 400, and the printer 200 to include the operation unit. The operation unit may be displayed in the UI of a browser such as Microsoft (registered trademark) Edge or Google (registered trademark) Chrome. The operation unit may also be displayed in the UI of a generative application UI such as ChatGPT, the UI of a printing application such as Microsoft (registered trademark) Office, or the UI of a chat application such as Microsoft Teams.

Additionally, although the foregoing embodiment describes print settings provided in a standard printer driver 1420, such as the number of copies, the orientation, the layout, and the like, the present invention is not limited thereto. The presence or absence of functions, such as staple settings, binding settings, or the like, may differ depending on the printer 200. In this case too, performing processing such as acquiring device information of the printer 200 in advance makes it possible to automatically set the print settings as described in the foregoing embodiment.

Additionally, it is conceivable that in the foregoing embodiment, the print settings data stored in the storage unit may actually have different data formats for sending and receiving, such as PrintTicket, devmode, or the like, due to differences in the OS 1400 and the printer driver 1420 or the like. The present invention can also be applied when sending and receiving a variety of data formats in such a manner. Furthermore, the foregoing embodiment assumes that the printer driver 1420 sends the print job to the printer 200 connected to the same internal network 500 as the computer 110 in step S637. However, the present invention is not limited thereto. For example, the configuration may be such that in step S637, the printer driver 1420 uploads the print job to a printing service in the cloud, and the print job is then printed by a printer connected to a different network from the computer 110 via the cloud.

Additionally, there are cases in the printing system 100 where, for example, the generative AI server 300 (called a “server” hereinafter) is located outside of Japan and the computer 110, which is a terminal apparatus (and will be called a “terminal apparatus” hereinafter) is located inside Japan. In this case as well, each file and item of data is sent from the server to the terminal device, and the terminal device can receive each file and item of data. In this manner, even if the server is located outside of Japan, files and data are sent and received (exchanged) in an integrated manner in the system. Because the system functions by the terminal apparatus located in Japan receiving each file and item of data, the sending and receiving can be considered to have been performed inside Japan. For example, in this system, even if the server is located outside Japan and the terminal apparatus is located inside Japan, the terminal apparatus can perform the main functions of the system, and the effects of those functions can be expressed inside Japan. For example, even if the server is located outside Japan, if the terminal apparatus constituting the system is located inside Japan, the system can be used domestically by using the terminal apparatus. The use of this system can affect the economic interests of the patent holder, for example.

Additionally, the foregoing embodiment describes a method in which the content is created by the printing application 1110. However, the present invention is not limited thereto, and rather than the printing application 1110 creating the content, content stored in the storage unit 103 of the computer 110 may be imported, for example, or content may be imported from an external storage apparatus such as a USB drive or an SD card.

Additionally, although the present embodiment describes the printing application 1110 and the generative AI client 1200 as separate configurations, the processing of the generative AI client 1200 may be included in the printing application 1110. Additionally, although the foregoing embodiment described the assist tool 1300 as being launched in response to a preview screen display instruction from the printing application 1110, the configuration is not limited thereto. For example, the tool may be automatically launched when the OS is started up, and may run in the background in the computer 110. In this case, the assist tool 1300 periodically accesses the print settings database 4300 to acquire the newest print settings registered in the database, and displays the print preview image by acquiring the content for which the print preview is to be displayed through any desired method. Additionally, the assist tool 1300 may be configured to automatically display the print preview image display UI 1170 upon the print settings being successfully acquired. Additionally, although the foregoing embodiment described the assist tool 1300 as generating the print preview image, the print preview image may be generated by a different program having a print preview image generation function.

Additionally, although the foregoing embodiment described the processing for acquiring the print setting information from the print settings database 4300 by the assist tool 1300 as being completed through a single instance of processing, the configuration is not limited thereto. For example, if the desired information cannot be acquired from the print settings database 4300, the print settings acquisition processing may be repeated for a set period of time. Additionally, the foregoing embodiment described using the IP address as the information for specifying the computer 110, recorded in the print settings database 4300 in association with the combination of the print settings. However, the present invention is not limited thereto, and information aside from the IP address may be used as long as that information can uniquely identify the computer 110. For example, a MAC address or an ID for uniquely identifying the computer 110 generated by an internal process of the assist tool 1300 may be used, and the value thereof may be associated with the print settings. Additionally, although the foregoing embodiment described recording the paper size, paper type, layout, and color mode information as items of the print settings stored in the print settings database 4300, other information may be recorded as well. For example, the printing quality, printing direction, whether to apply stapling, paper feed port settings, and other items related to printing may be recorded.

### Second Embodiment

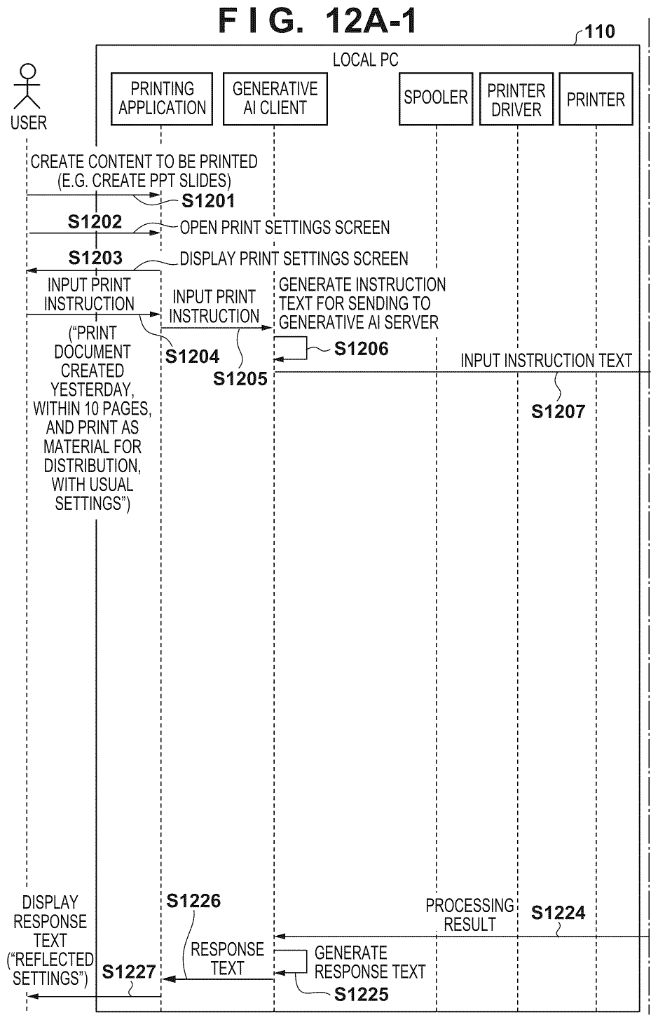

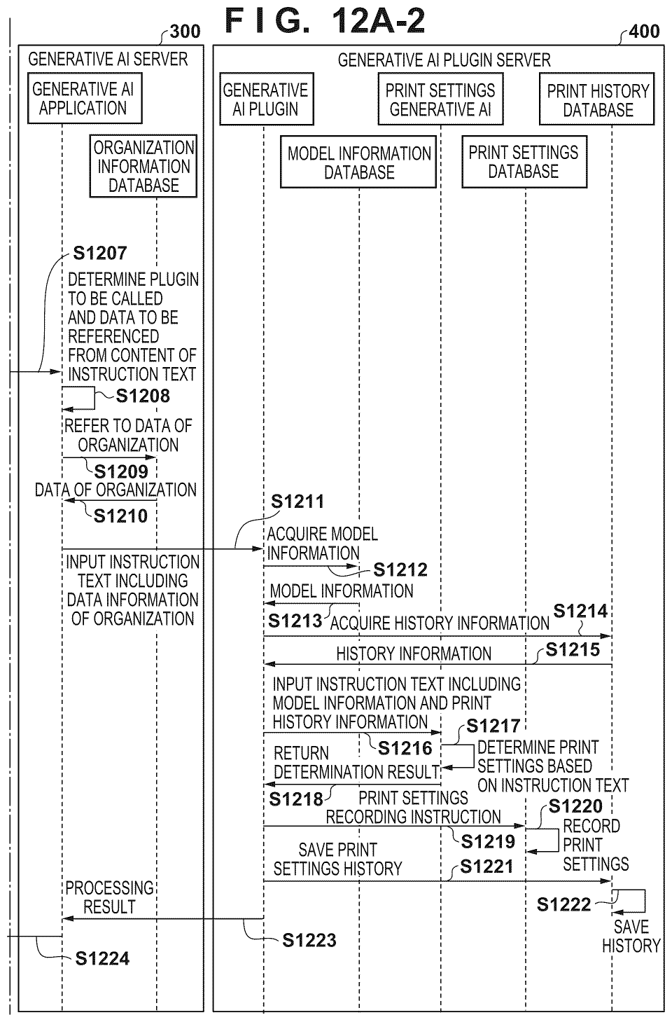

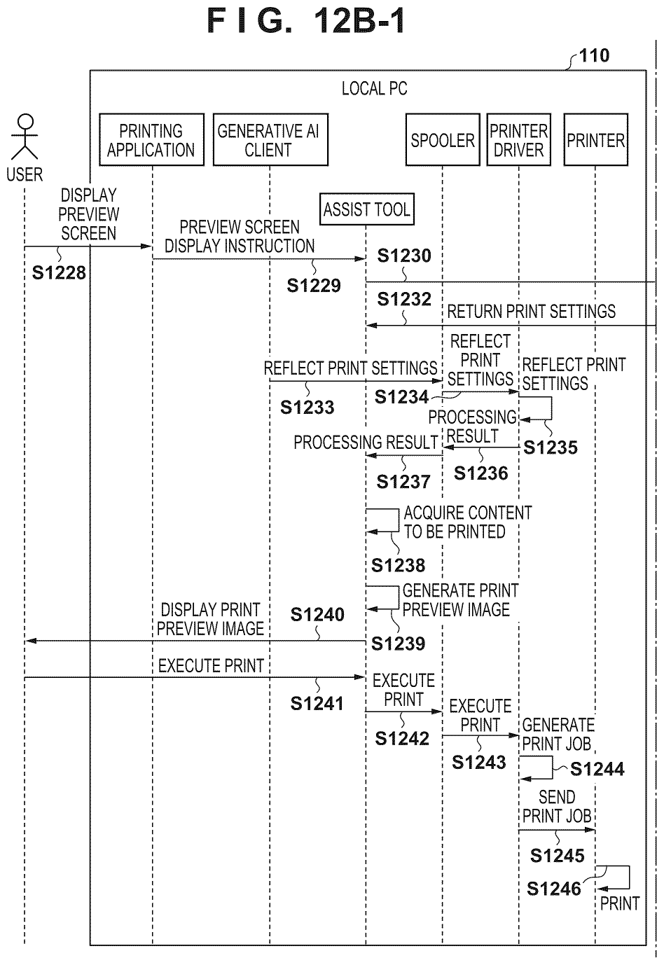

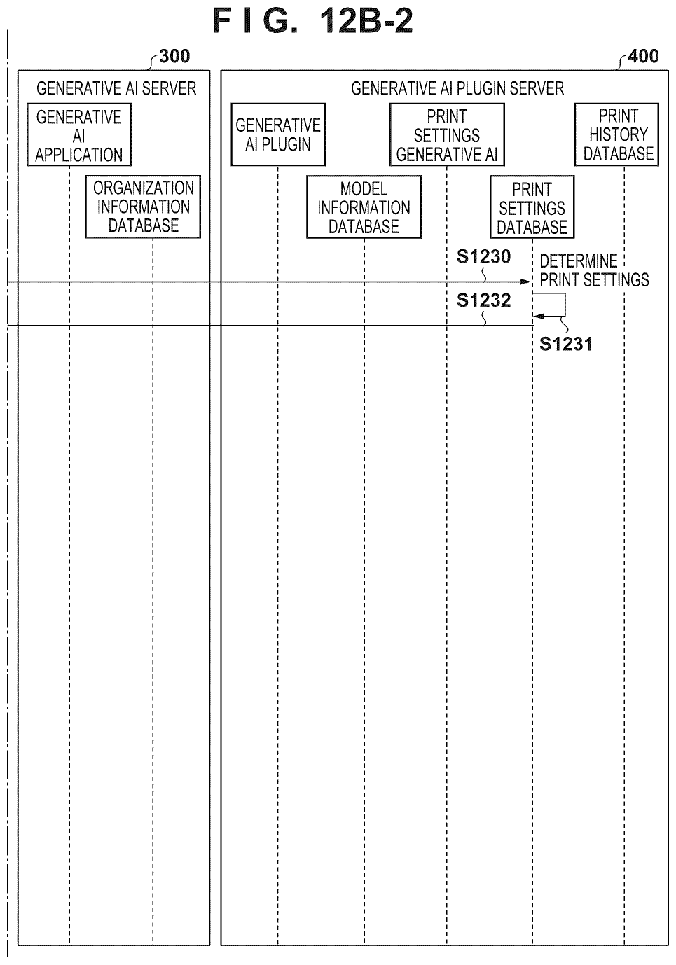

A second embodiment of the present invention will be described hereinafter. In the present embodiment, configurations identical to those in the foregoing first embodiment will be given the same reference signs, and will not be described. A sequence of processing performed among the elements constituting the computer 110, the generative AI server 300, and the generative AI plugin server 400 according to the present embodiment will be described next with reference to FIGS. 12A-1 to 12B-2. The numbers following “S” hereinafter indicate step numbers in the sequence.

In step S1201, the printing application 1110 creates desired content in accordance with operation instructions made by the user. Presentation slides, documents, charts, graphs, and the like can be given as examples of the content. After the content has been created, in step S1202, the printing application 1110 accepts an instruction from the user, and in step S1203, displays the print settings screen 1111 on the display unit 101. Next, in step S1204, the printing application 1110 accepts a print instruction for performing desired printing using natural language through the instruction input part 1152 in the print settings screen 1111. An example of the printing instruction is an instruction including conditions used when printing, such as “print the document created yesterday, within 10 pages, and print as material for distribution, with the usual settings”, and the content to be printed (which may be different from content currently being created). In step S1205, the printing application 1110 inputs the print instruction input by the user, the IP address of the computer 110, the printer name (print queue name) selected as the destination for sending the print job, and the like to the generative AI client 1200.

Upon receiving the print instruction, in step S1206, the generative AI client 1200 generates instruction text to be sent to the generative AI server 300 using the received information. The IP address of the computer 110 for specifying the source of the instruction text, the printer name selected in the print settings screen 1111 as the destination for sending the print job, and the like are added to the instruction text as additional information, in addition to the print instruction input by the user. Next, in step S1207, the generative AI client 1200 sends the generated instruction text to the generative AI application 3110 of the generative AI server 300.

Upon receiving the instruction text, in step S1208, the generative AI application 3110 interprets the content of the instruction text and determines the generative AI plugin 4100 to be called and data to be referenced. In the present embodiment, the user specifies “the document created yesterday” as the file to be printed. Accordingly, in steps S1209 and S1210, the generative AI application 3110 refers to the organization information database 3500 as the data to be referenced, and acquires information on the corresponding file. A URL indicating the storage destination of the file to be printed can be given as an example of the information acquired here. Then, in step S1211, the generative AI application 3110 inputs the instruction text to the determined generative AI plugin having the information on the file to be printed, acquired in step S1210, to the instruction text received from the generative AI client 1200.

Upon receiving the instruction text, in steps S1212 and S1213, the generative AI plugin 4100 uses the printer name selected as the destination for sending the print job included in the received instruction text as a key, and acquires model-specific information corresponding thereto from the model information database 4500. The model-specific information acquired includes a list of paper sizes that can be used in the corresponding model, post-processing that can be used (stapling), and information on whether layout printing can be used. Next, in steps S1214 and S1215, the generative AI plugin 4100 uses the user identification information 705 included in the received instruction text as a key, and acquires print history information of printing executed by the user who made the print instruction from the print history database 4600. The print history information acquired includes information on combinations of the print settings set during printing in the past (e.g., the paper size, whether layout printing was used, the post-processing information used, and the like).

Then, in step S1216, the generative AI plugin 4100 inputs, to the print settings generative AI 4200, instruction text to which the information acquired in steps S1213 and S1215 has been added. In step S1217, the print settings generative AI 4200 determines an optimal combination of print settings for obtaining the output result desired by the user by interpreting the various types of information included in the instruction text and the content to be printed. Next, in step S1218, the print settings generative AI 4200 returns the determined combination of print settings to the generative AI plugin as a determination result.

Upon receiving this response, in steps S1219 and S1220, the generative AI plugin 4100 records the combination of the print settings included in the response, the IP address of the computer 110 included in the instruction text received in step S1211, and the printer name in association with each other in the print settings database 4300. Furthermore, in steps S1221 and S1222, the generative AI plugin 4100 records the combination of print settings included in the response in the print history database in association with the user identification information 705. Next, in step S1223, the generative AI plugin 4100 returns the response received in step S1218 to the generative AI application 3110 as a result of the processing performed in step S1211. The subsequent processing of steps S1224 to S1246 is the same as that of steps S616 to S638, and will therefore not be described here.

As described above, according to the present embodiment, optimal print settings can be automatically determined by the print setting generative AI interpreting information acquired from the organization information database 3500, the model information database 4500, and the print history database, in addition to a print instruction made by a user using natural language. For example, even when the user has instructed the printing of content different from the content being created by the printing application 1110, a print instruction for content created in the past can be made by referring to the information recorded in the organization information database 3500. Furthermore, by inputting the information recorded in the model information database 4500 to the print settings generative AI 4200, the print settings generative AI 4200 can estimate the optimal print settings after understanding information unique to the printer to which the print job is to be sent. Furthermore, by inputting the information recorded in the print history database 4600 to the print settings generative AI 4200, the optimal print settings can be estimated having understood the print settings information used by the user in the past.

Although the present embodiment described a sequence in which information acquired from the model information database 4500, the print history database 4600, and the like is always added as input information to the print settings generative AI 4200, the method for determining the information to be input to the print settings generative AI 4200 is not limited thereto. For example, the generative AI plugin 4100 may acquire the information from the various databases having first determined whether to use the information in the model information database 4500, the print history database, and the like by inputting the instruction text input by the user to the print settings generative AI.

Additionally, although the organization information database 3500, the model information database 4500, and the print history database 4600 have been described as configurations provided in the generative AI server 300 and the generative AI plugin server 400, another configuration may be used instead. For example, the organization information database 3500 may be provided on a server different from the server on which the generative AI application 3100 operates. Likewise, the model information database 4500 and the print history database 4600 may be provided on a server different from the server on which the generative AI plugin 4100 operates.

Additionally, although the present embodiment described an example in which the generative AI application 3100 acquires content information acquired from the organization information database 3500, the information acquired is not limited thereto. For example, print settings that an administrator of an organization intends to apply throughout the organization may be registered in the organization information database 3500. In this case, the generative AI application 3100 can add the print setting information specified by the administrator to the instruction text for the generative AI plugin 4100 by acquiring the print setting information from the organization information database 3500. Through this, the print settings generative AI 4200 can determine optimal print settings in consideration of the print settings that the administrator of the organization intends to apply throughout the organization.

### Third Embodiment

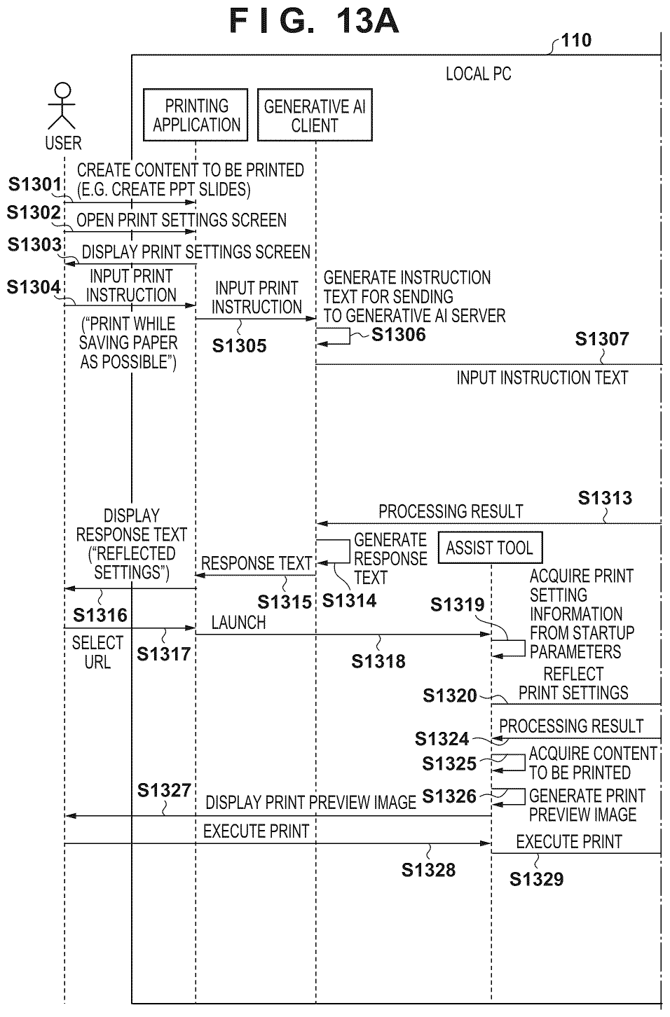

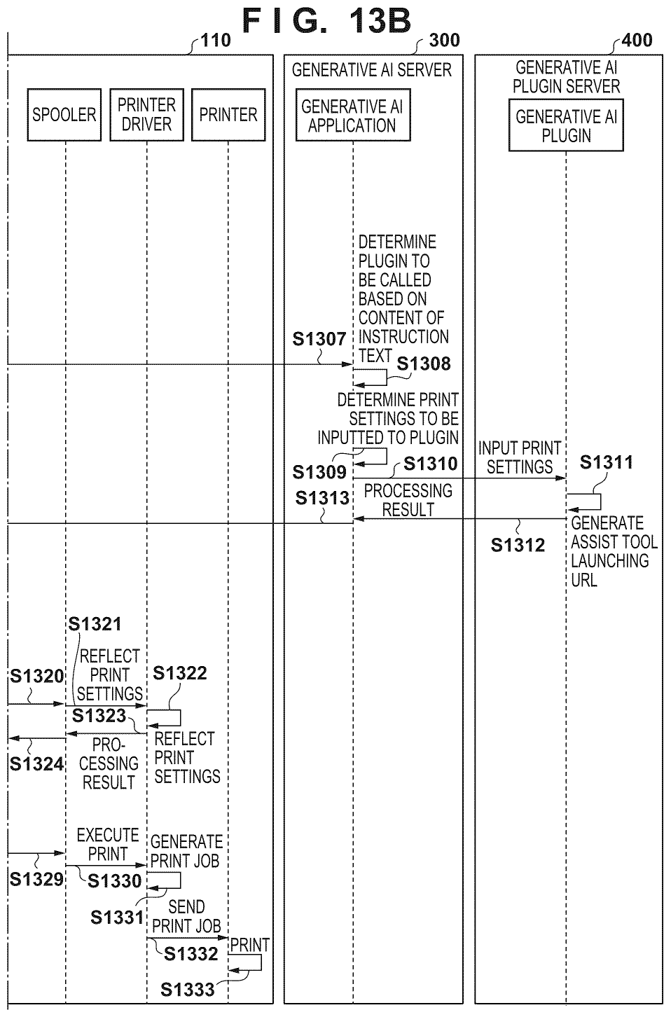

A third embodiment of the present invention will be described below. A sequence of processing performed among the elements constituting the computer 110, the generative AI server 300, and the generative AI plugin server 400 according to the present embodiment will be described next with reference to FIGS. 13A-13B. The numbers following “S” hereinafter indicate step numbers in the sequence.

In step S1301, the printing application 1110 creates content to be printed in accordance with operation instructions made by the user. Presentation slides, documents, charts, graphs, and the like can be given as examples of the content. After the content has been created, in step S1302, the printing application 1110 accepts an instruction from the user, and in step S1303, displays the print settings screen 1111 on the display unit 101. Next, in step S1304, the printing application 1110 accepts a print instruction for performing desired printing using natural language through the instruction input part 1152 in the print settings screen 1111. An example of the printing instruction is an instruction that includes conditions for printing, such as “print while saving as much paper as possible”. In step S1305, the printing application 1110 inputs the print instruction input by the user, the IP address of the computer 110, the printer name (print queue name) selected as the destination for sending the print job, and the like to the generative AI client 1200.

Upon receiving the print instruction, in step S1306, the generative AI client 1200 generates instruction text to be sent to the generative AI server 300 using the received information. The IP address of the computer 110 for specifying the source of the instruction text, the printer name selected in the print settings screen 1111 as the destination for sending the print job, and the like are added to the instruction text as additional information, in addition to the print instruction input by the user. Next, in step S1307, the generative AI client 1200 sends the generated instruction text to the generative AI application 3110 of the generative AI server 300.

Upon receiving the instruction text, in step S1308, the generative AI application 3110 interprets the content of the instruction text and determines the generative AI plugin 4100 to be called. Next, in step S1309, the generative AI application 3110 determines the print settings to be input to the generative AI plugin 4100 by interpreting the details of the instruction text. Then, in step S1310, the generative AI application 3110 inputs the instruction text received from the generative AI client 1200 to the generative AI plugin determined. For example, in the present embodiment, the generative AI application 3110 determines that print settings in which a paper size of A4 is selected, double-sided printing is selected, and layout printing is enabled are in effect, in response to an instruction to “print while saving paper”. In the case of such a determination, the information input in step S1310 includes information on these settings. Upon receiving the print setting information, in step S1311, the generative AI plugin 4100 generates a URL for launching the assist tool 1300. In addition to a character string instructing the assist tool 1300 to start, the URL includes a character string expressing the print settings determined by the generative AI application 3110 in step S1309. An example of the generated character string is “assisttool:size=A4&duplex=True&layout=4”. Here, “assisttool:” is a character string instructing the assist tool 1300 to be launched. “size=A4&duplex=True&layout=4” means that the paper size is A4 and double-sided printing is enabled, and furthermore, an instruction to print four pages of content per page (layout printing) has been made. Next, in step S1312, the generative AI plugin 4100 returns the URL generated in step S1311 as a result of the processing performed in step S1310.

Then, in step S1313, the generative AI application 3110 returns the processing result received in step S1313 to the generative AI client 1200 as a result of the processing performed in step S1307. Next, in step S1314, the generative AI client 1200 generates response text for the printing application 1110 from the received processing result. The response text is text in natural language including the character string instructing the assist tool 1300 to be launched, generated by the generative AI plugin 4100 in step S1311, and is displayed in the generative AI control 1150. In step S1315, the generative AI client 1200 responds to the printing application 1110 using the response text generated as a result of the processing performed in step S1305. In step S1316, the printing application 1110 displays the received response text to the user in the chat display region 1151. A message prompting the assist tool 1300 to be launched, along with the URL for launching the assist tool 1300 (“please select this URL to launch the assist tool. assisttool:size=A4&duplex=True&layout=4”) can be given as an example of the response text.

When the user selects the URL for launching the assist tool 1300 displayed in the chat display region 1151 in step S1317, the printing application 1110 launches the assist tool 1300. At this time, the printing application 1110 specifies “size=A4&duplex=True&layout=4”, which is the character string indicating the print setting information included in the URL, in the assist tool 1300. Furthermore, the printing application 1110 specifies information on the location (the file path name) where the content to be printed is stored as a startup parameter in the assist tool 1300.

In step S1319, the assist tool 1300 acquires the print setting information from the character string indicating the print setting information input as startup parameters. Specifically, by analyzing “size=A4&duplex=True&layout=4”, information on the paper size, whether double-sided printing is effective, and whether layout printing is effective is acquired. The paper size being A4 and double-sided printing being enabled, and furthermore, an instruction to print four pages of content per page (layout printing) having been made, can be acquired from the stated character string. The subsequent processing of steps S1320 to S1324 is the same as that of steps S625 to S629, and will therefore not be described here. In step S1325, the assist tool 1300 acquires the content to be printed on the basis of the information on the location where the content to be printed is stored, received in step S1318 as one of the startup parameters. The subsequent processing of steps S1326 to S1333 is the same as that of steps S631 to S638, and will therefore not be described here.

As described above, a printing system according to the present embodiment is configured including a user terminal, a generative AI server that provides a generative AI service, an information processing apparatus that extends a function of the generative AI service, and a printing apparatus. According to the present embodiment, optimal print settings can be automatically determined by a generative AI application interpreting a print instruction made by a user using natural language. Through this, a URL for the generative AI plugin 4100 to launch the assist tool 1300, including the print setting information determined by the generative AI application 3110, can be created. The URL created by the generative AI plugin 4100 is ultimately presented to the user, and by selecting the URL, the user can print using the print settings determined automatically by the assist tool 1300. Although the present embodiment described the paper size, whether double-sided printing is enabled, and whether layout printing is enabled as the print setting information included in the URL generated by the generative AI plugin 4100, the print settings that can be included in the URL are not limited thereto. For example, other print settings such as the paper type, the paper feed port used for printing, and information on the color used for printing (color or black and white) may be included.

According to the present invention, it is possible to appropriately determine print settings on the basis of a printing instruction input as natural language.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-024828, filed Feb. 21, 2024, and Japanese Patent Application No. 2024-064797, filed Apr. 12, 2024, which are hereby incorporated by reference herein in their entirety.

What is claimed is:

1. A non-transitory computer-readable storage medium storing a computer program that extends a function of a generative AI service, the computer program causing a computer of an information processing apparatus to:
acquire, from a user terminal, a natural language input related to a print instruction from a user, the print instruction being accepted through the generative AI service;
determine a print setting on the basis of the natural language input related to the print instruction; and
return the determined print setting to the user terminal.

2. The storage medium according to claim 1,
wherein the computer program further causes the computer of the information processing apparatus to:
acquire identification information of a printing apparatus selected, in addition to the natural language input related to the print instruction, and
acquire, on the basis of the natural language input and the identification information of the printing apparatus, a print setting that can be specified by the printing apparatus from a database storing print settings in advance.

3. The storage medium according to claim 2,
wherein the computer program further causes the computer of the information processing apparatus to store the determined print setting in the database in association with identification information of an apparatus that has requested the print instruction and the identification information of the selected printing apparatus.

4. The storage medium according to claim 3,
wherein the database further stores at least one of (i) organization information including content created within an organization that can use the generative AI service, (ii) model-specific information associated with each of models of printing apparatuses, and (iii) print history information for each of users, and
the computer program further causes the computer of the information processing apparatus to determine the print setting on the basis of at least one of the organization information, the model-specific information, and the print history information, in addition to the natural language input related to the print instruction.

5. The storage medium according to claim 4,
wherein the print instruction includes user identification information, and
the computer program further causes the computer of the information processing apparatus to use the print history information stored in association with the user identification information.

6. The storage medium according to claim 1,
wherein the computer program further causes the computer of the information processing apparatus to:
generate a URL that reflects the determined print setting, the URL being a URL for access from the user terminal; and
return the URL to the user terminal instead of the print setting.

7. The storage medium according to claim 6,
wherein the computer program further causes the computer of the information processing apparatus to include information on a location where content to be printed is stored, along with information on the print setting, as startup parameters of the URL.

8. A non-transitory computer-readable storage medium storing a computer program that uses a generative AI service, the computer program causing a computer of a user terminal to:
accept a natural language input related to a print instruction from a user, through a generative AI interaction region in a settings screen;
generate instruction text to the generative AI service on the basis of the natural language input accepted;
send the instruction text generated to the generative AI service, and acquire a print setting determined by a plugin that extends a function of the generative AI service; and
cause the user to confirm, through the settings screen, the print setting acquired.

9. The storage medium according to claim 8,
wherein the computer program further causes the computer of the user terminal to inquire with the user, through the generative AI interaction region of the settings screen, as to whether to execute printing using the print setting acquired.

10. The storage medium according to claim 8,
wherein the settings screen includes a region for selecting a printing apparatus to perform printing, and a setting region for making a print setting, in accordance with a user input.

11. The storage medium according to claim 10,
wherein the setting region related to the print setting reflects the print setting acquired in the acquiring.

12. The storage medium according to claim 10,
wherein the settings screen further includes an operation object that accepts an instruction to display a preview image.

13. The storage medium according to claim 12,
wherein the computer program further causes the computer of the user terminal to, when the instruction to display the preview image is made through the operation object, acquire a corresponding print setting from a database storing the print setting determined by the plugin, generate a preview image of content to be printed in accordance with the print setting acquired, and display, to the user, a screen displaying the preview image.

14. The storage medium according to claim 13,
wherein an operation object for instructing printing to be performed is displayed in the screen displaying the preview image.

15. A control method for an information processing apparatus that extends a function of a generative AI service, the control method comprising:
acquiring, from a user terminal, a natural language input related to a print instruction from a user, the print instruction being accepted through the generative AI service;
determining a print setting on the basis of the natural language input related to the print instruction; and
returning the determined print setting to the user terminal.

16. A control method for a user terminal that uses a generative AI service, the control method comprising:
accepting a natural language input related to a print instruction from a user, through a generative AI interaction region in a settings screen;
generating instruction text to the generative AI service on the basis of the natural language input accepted;
sending the instruction text generated to the generative AI service, and acquiring a print setting determined by a plugin that extends a function of the generative AI service; and
causing the user to confirm, through the settings screen, the print setting acquired.

17. A printing system comprising a user terminal, a generative AI server that provides a generative AI service, an information processing apparatus that extends a function of the generative AI service, and a printing apparatus,
wherein the user terminal includes:
one or more first memory devices that store a set of instructions; and
one or more first processors that execute the set of instructions to:
accept a natural language input related to a print instruction from a user, through a generative AI interaction region in a settings screen;
generate instruction text to the generative AI service on the basis of the natural language input accepted;
send the instruction text generated to the generative AI service, and acquire a print setting determined by a plugin that extends a function of the generative AI service; and
cause the user to confirm, through the settings screen, the print setting acquired, and
the information processing apparatus includes:
one or more second memory devices that store a set of instructions; and
one or more second processors that execute the set of instructions to:
acquire the instruction text from the user terminal;
determine a print setting on the basis of the natural language input related to the print instruction; and
return the determined print setting to the user terminal.
